(19) United States
(12) Patent Application Publication
(10) Pub. No.: US 2002/0012471 A1
(43) Pub. Date: Jan. 31, 2002

(54) Multimedia compression/decompression and compressed data representation

(75) Inventor: Arjun Nayyar, Los Angeles, CA (US)

Correspondence Address: Anna M. Vradenburgh, Brull, Piccionelli, Sarno, Braun & Vradenburgh, Suite 2350, 1925 Century Park East, Los Angeles, CA, 90067, US

(73) Assignee: Wildform, Inc.

(21) Appl. No.: 09/880,169

(22) Filed: Jun. 13, 2001

Related U.S. Application Data
(60) Provisional application No. 60/212,065, filed on Jun. 14, 2000.

(51) Int. Cl. G06K 9/36

(52) U.S. Cl. 382/239

(57) ABSTRACT

Preferred embodiments of the present invention are directed to a system, method and apparatus for adaptively compressing and decompressing regions of an image depending on the properties of the uncompressed data regions. Preferred embodiments of the compression and decompression process of the present invention comprise a compression process and a decompression process, wherein the compression process comprises segmenting an image into a plurality of segments, analyzing each segment to determine an optimal compression technique, and compressing the segment in accordance with the chosen compression technique. After the optimal compression is applied to the segment, the segment is stored in computer memory and the compression process increments to the next segment of the image frame. Once the image stream has been processed, temporal compression is performed and the compressed image stream is stored for later use. When a user desires to view the compressed image data, each image is decompressed utilizing the complementary decoding techniques for each segment of each image. Upon decompression of each image, the results are displayed on a display device.

This application is based on U.S. Provisional Application, Ser. No. 60/212,065, filed Jun. 14, 2000, and is fully incorporated herein by reference.

### FIELD OF THE INVENTION

The present invention is directed to the transmission and rendering of multimedia data on a computer system, wherein the multimedia data can include a wide variety of data, including, but not limited to, digitized video and digitized audio in compressed or uncompressed form. More specifically, embodiments of the present invention are directed to the use of a tagged file format containing audio data, image data, user interface controls and interactivity commands governing the interaction of audio data, image data, and other data within one or multiple multimedia sessions, wherein the data are synchronized, formatted, stored, transmitted, and rendered on computer systems.

### BACKGROUND OF THE INVENTION

Video tapes are a popular medium for storing a variety of video information, or data, as video tape is relatively inexpensive, convenient to store and easy to use. Indeed, due to the relatively low cost and convenience of storage, video tapes are popular among consumers, including prerecorded and blank video tape.

Video tape can store any type of information, such as movies, documentaries, lectures, events, images of a location or a person, and the like. Generally, video information is stored and conveyed as a series of discrete frames of data which are transmitted for viewing in rapid succession. The rapid succession of the video frame series, or video stream, creates the illusion of movement from one image to another image.

Storage of video information, or data, is not limited to a tape medium, but rather, can also be stored on virtually any type of medium, including, for example, hard drives, floppy disks, DVDs and CD Roms. Unfortunately, the storage requirements for video information can be quite large. Thus, to store video data on computer readable mediums, such as, hard drives, floppy disks, DVDs and CD Roms, methods of compressing the data representing the video stream have been developed and employed over the years. Indeed, the compression of digital data has been an ongoing concern in the field of computer science since the early days of computers.

Techniques for compressing streams of video data expand on the concepts utilized to compress single images by applying the compression techniques used to compress a single image to a plurality of images which represent the video stream of data. Compression of the data within a single video frame is spatial compression. In addition to compressing the data within a single frame, the frames adjacent each other in the video stream can also be compressed. Compression of a plurality of successive and adjacent frames in the video stream is temporal compression. Temporal compression, which utilizes the duplication of information across multiple image frames in the video stream, allows for greater compression ratios than would be achieved through spatial compression alone. By using a combination of temporal and spatial compression, the data required to represent a compressed video stream is greatly reduced in comparison to the full set of data that represents the uncompressed video stream.

Most single image frames in a video stream contain multimedia data, that is, a variety or combination of various types of data, wherein each of the various types of data create an identifiable stream of data. See FIG. 1. Each of the identifiable data streams are multiplexed into a single stream, thereby creating a multimedia data stream. For instance, a video data stream typically contains both an image data stream and audio data stream. Due to the differences in the type of data, different compression techniques are applied to each discrete data stream in the multiplexed video data stream, wherein the compression technique applied depends upon the nature of the data carried in each discrete data stream. For example, a technique known as perceptual audio compression can be applied to an audio stream and a block-coded algorithm, for example, Motion Pictures Expert Group (“MPEG”), could be applied to the image data stream. The audio and image data streams are then multiplexed and synchronized to create a cohesive presentation of the audio-image data for the viewer.

Generally, once a compression technique is chosen to encode image data or audio data, the compression algorithm is applied to the complete multimedia stream without consideration to the changing properties of the data being compressed. However, compression algorithms have differing performance characteristics depending on the content of the image data being compressed. For example, block based compression algorithms, such as, a joint picture expert group (“JPEG”), generally perform poorly when compressing image data with well-defined boundaries or lines, but perform well compressing images with continuous tones of color or gradual gradation between colors. A lossless compression algorithm, such as GIF or PNG, provides excellent performance when compressing image data containing lines and flat shades of colors, but poorly if compressing image data containing gradual gradation of tones of color. Image data may contain regions with continuous tone colors and regions with sharp and well-defined lines, thus, requiring a compromise as to the manner in which to compress the image. As all of the different segments of the data are not being optimally compressed due to the application of a single compression technique, the resulting image contains regions of poor data quality. In addition to one spacial compression algorithm being applied to each image, a single type of temporal compression is usually chosen and applied to the sequence of images in the video stream, thus creating regions of poor compression performance within the video stream. The application of a single spacial compression technique in combination with the application of a single temporal compression technique results in the reduction of overall quality of the video stream produced by the compressed data.

A need in the industry exists for a compression system that can incorporate various types of compression algorithms and, depending upon the nature of the region under compression, compress different regions of an image or video stream with a compatible compression algorithm. In addition, a need exists for a compression algorithm that can adapt to the changing properties of a specific image region throughout the sequence of image data in the spatial and temporal domains, thereby minimizing the entropy required to adequately represent a sequence of images.

### SUMMARY OF THE DISCLOSURE

Preferred embodiments of the present invention are directed to a system, method and apparatus for adaptively compressing and decompressing regions of an image depending on the properties of the uncompressed data regions in the spatial domain, and further, for adaptively applying temporal compression and decompression to different regions of an image in a sequence of images in a video stream, wherein the temporal compression and decompression applied depends upon the temporal properties of the image data in the given video sequence. Preferred embodiments of the compression and decompression process of the present invention comprise a compression process and a decompression process. In preferred embodiments, the compression process comprises segmenting an image into a plurality of segments, or regions, analyzing each segment to determine an optimal compression technique for the segment, and compressing the segment in accordance with the chosen compression technique to reduce the image's memory requirement.

In preferred embodiments, the image is segmented into non-overlapping and square regions, although any segmentation is suitable, including, but not limited to, segments which are overlapping or arbitrarily shaped. After the image is segmented into a plurality of segments, the segments are analyzed to determine the compressibility under different compression schemes, wherein the optimal compression depends, in part, on the resulting quality of the segment and the resulting memory requirement of the compressed image in total.

The compression techniques applied to the segmented image are chosen from a variety of techniques, including, but not limited to, “block” compression of spectral coefficients, loss-less dictionary based techniques, contractive transformations, bitmap conversion to lines, or any other technique or combination of techniques.

Once the quality and memory requirements are ascertained, the optimal compression technique is selected for the given segment. Once selected, the optimal compression technique is applied to the pixels in the segment of data. After the optimal compression is applied to the segment, the segment is encoded and stored in computer memory. Once the segment is stored, the compression process increments to the next segment of the image frame, wherein the subsequent segment is analyzed. The above described steps are repeated until the last segment of the image frame is stored in memory.

After all of the segments in the image frame are analyzed, compressed and stored, the audio frames are added. To complete the series of images in the data stream, the next image is read into the computer system and the above described process is repeated until no additional images remain in the data stream for processing.

Once the image stream has been processed, temporal compression is performed, wherein the redundancy of data between images in the image stream, or sequence, is encoded. In some preferred embodiments, the temporal compression occurs simultaneously with the spatial compression.

After the image stream has been compressed, the compressed image stream is stored for later use. When a user desires to view the compressed image data, the decompression process is engaged wherein the image data is decompressed utilizing the complementary decoding techniques for each segment of each image. Upon decompression of each image, the results are displayed on a display device.

A feature of preferred embodiments of the present invention is the segmentation of each image frame. An advantage to this feature is that the varying types of data contained within the image frame can be better separated for processing during compression of the image frame.

A still further feature of preferred embodiments of the present invention is the application of a plurality of compression techniques to a single image frame in an image stream. An advantage to this feature is that a better compression of the image frame can be achieved, and ultimately a better compression of the image stream. A further advantage to this feature is that the overall compression of the image frame can reduce the storage requirements in comparison to the storage requirements of a image frame compressed by a single compression technique.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of the embodiments of the invention will be made with reference to the accompanying drawings, wherein like numerals designate corresponding parts in the figures.

FIG. 1 is a schematic representation of a video stream.

FIG. 2 is a computer system in accordance with a preferred embodiment of the present invention.

FIG. 3 is a block diagram of the compression process in a preferred embodiment of the present invention.

FIG. 4 is a segmented image having non-overlapping and square regions in accordance with the preferred embodiment of the present invention.

FIG. 5 is a schematic representation of the temporal compression of an image stream in accordance with the preferred embodiment of the present invention.

FIG. 6 is a schematic representation of a video stream having delta frames of the preferred embodiment of FIG. 1.

FIG. 7 is a block diagram of the decoding process in a preferred embodiment of the present invention.

FIG. 8 is a schematic representation of a digitized multimedia stream de-multiplexed into an audio video stream.

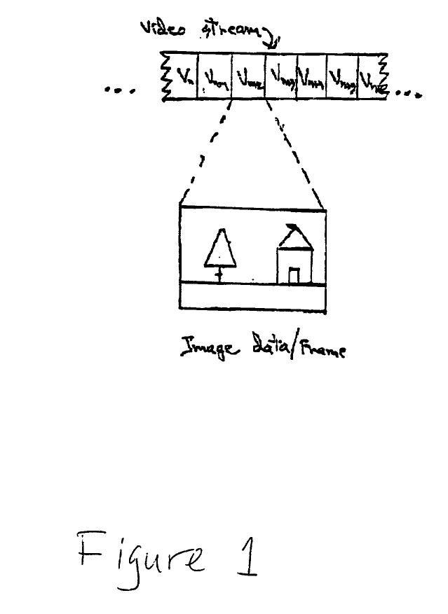

### DETAILED DESCRIPTION OF THE PREFERRED EMBODIMENTS

Preferred embodiments of the method and apparatus for an adaptive compression and decompression of multimedia data operate on a stand-alone computer or a network, such as, for example, the WWW, or another type of remote access system, such as, personal digital assistant, pulse code system, web TV, or any other network device.

In the following description, for purposes of explanation, numerous specific details are set forth to provide an understanding of the present invention. It will be evident, however, to one skilled in the art, that the embodiments of the present invention may be practiced without these specific details. In other instances, well-known structures and devices are shown in block diagram form in order to facilitate description of the embodiments of the present invention.

### Hardware Environment

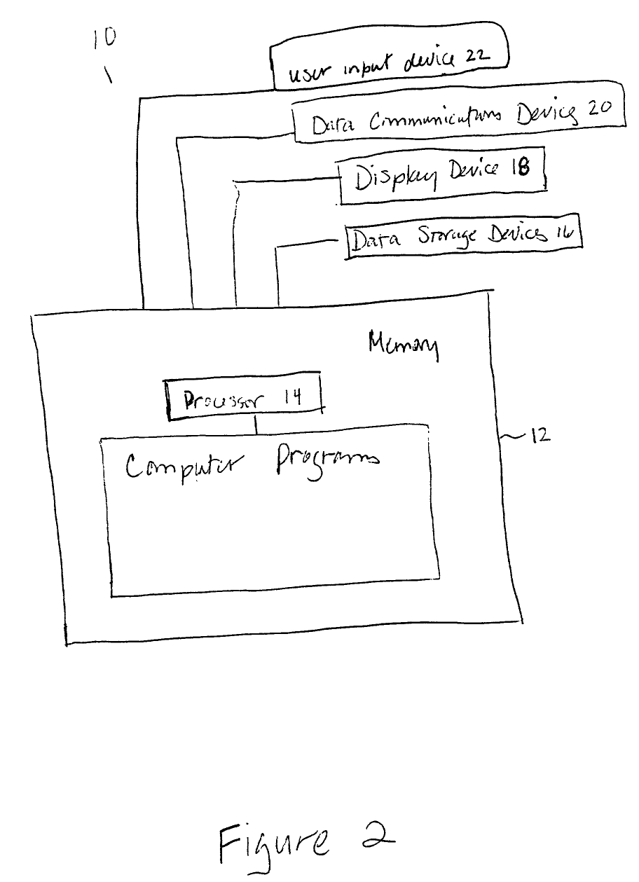

FIG. 2 depicts a computer system 10 that operates in accordance with preferred embodiments of the invention. In preferred embodiments, the computer system 10 includes at least one computer 12, comprising a programmable processor 14 capable of operating in accordance with programs stored on one or more data storage devices 16 (for example, but not limited to floppy disc, hard disc, computer network, random access memory (RAM), CD Rom, or the like), a display device 18 for providing a user-perceivable display (for example, but not limited to visual displays, such as cathode ray tube CRT displays, light-emitting-diode LED or liquid-crystal-diode LCD displays, plasma displays or the like, audio displays or tactile displays), data communications devices 20 (modems, networks interfaces) and a user input device 22 (for example, but not limited to, a keyboard, mouse, microphone, or the like). In one preferred embodiment, the computer 12 comprises a personal computer system having a CRT display, a keyboard and a mouse user-input device. It is envisioned that other devices, including, but not limited to, read only memory (ROM), a video card, bus interface, and printers may be coupled to the computer 12.

Embodiments of the present invention operate in accordance with machine-executable software instructions, stored on the data storage device 16, including, but not limited to, floppy disks, hard disks, RAM and CD-ROM, which are executed on the computer 12 by the processor 14. Generally, the software instructions, or computer programs, are embodied in, and/or readable from, a device, carrier, or media, such as memory, data storage devices, and/or a remote device coupled to the computer 12 via the data communications devices 20. The programs can be loaded from the memory, data storage devices and/or remote devices into the memory of the computer 12 for use during actual operations. In other embodiments, hardwired circuitry may be used in place of, or in combination with, the computer programs to implement the embodiments of the present invention.

Those skilled in the art will recognize the exemplary environment illustrated in FIG. 2 is not intended to limit the present invention. Indeed, those skilled in the art will recognize that other alternative hardware environments may be used without departing from the scope of the present invention.

### General Description

Preferred embodiments of the present invention are directed to a process of adaptively compressing an image frame or a series of images, wherein predefined segments of each image frame are compressed in accordance with a compression technique suitable for the data within the predefined segment of the image. These techniques can be applied to a series or sequences of digital images, wherein adjacent images are analyzed for common data and compressed to occupy less memory in the storage device of the computer system. However, to simplify the initial discussion, the description is directed to the spatial compression of a single image frame.

Overall, preferred embodiments of a compression process of the present invention comprises segmenting an image Iₙ, into Sᵢ, segments, or regions, analyzing each segment to determine an optimal compression technique for the segment, and compressing the segment in accordance with the chosen compression technique to reduce the image's memory requirement. The compressed image Iₙ is encoded into a storable and transmittable form prior to the commencement of the compression of the next image (Iₙ₊₁)

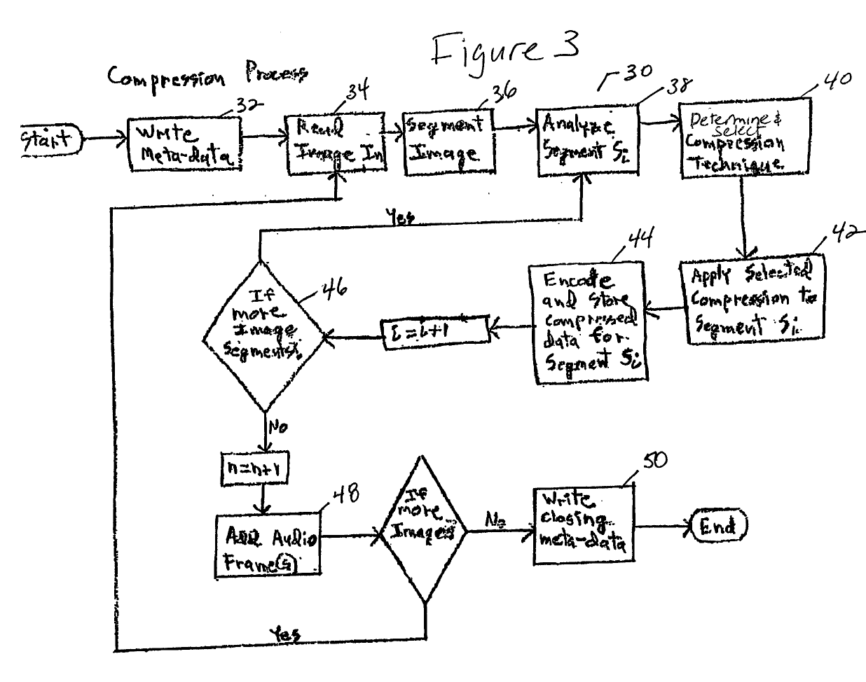

With reference to FIG. 3, upon the initiation of the compression process 30, meta-data is written 32, wherein meta-data is any type of additional information that the playback device, such as the computer 12, can read and interpret from the data stream. In preferred embodiments, the meta-data are instructions or descriptions of other data written to the stream that identify characteristics of the current stream or frame, including, but not limited to, the dimensions, the type of compression and the frame rate. In addition, the meta-data can include, but is not limited to, descriptions such as the title of the video clip, a description of the content, or a copyright notice.

Once the meta-data is written, the image Iₙ is read into the processor 34. The image Iₙ is then segmented into Sᵢ segments 36. With reference to FIG. 4, in one preferred embodiment, the image Iₙ is segmented into non-overlapping and square regions. In other preferred embodiments, the image Iₙ is segmented into overlapping or arbitrarily shaped regions.

After the image is segmented into Sᵢ segments, the segments are analyzed 38 to determine the compressibility under different compression schemes. To determine optimal compressibility, the pixels in each segment, or region, are analyzed. The optimal compression is based upon the resulting perceptual quality of the segment and the resulting memory requirement of the compressed image in total, that is, the highest resulting compression. Thus, for example, the data type of a particular segment is reviewed, and depending upon the nature of a majority of the data, a compression technique is chosen that is suitable for a majority of the data. It is to be understood that, in some embodiments, if a determination is made that multiple types of data are contained within a given segment such that a single compression technique would not be suitable for a large portion of the segment, the segment can be further divided such that a suitable compression technique could be applied for each subdivision of the segment.

Once the quality and memory requirements are ascertained, the optimal compression technique is selected for the given segment 40. Once selected, the optimal compression technique is applied to the pixels in the segment of data 42. After the optimal compression is applied to the segment Sᵢ, the segment is encoded, discussed below, and stored in computer memory 44.

Once segment Sᵢ is stored, the compression process increments to the next segment Sᵢ₋₁ 46. Segment Sᵢ₊₁ is analyzed and the above described steps are repeated until the last segment Sⱼ is stored in memory.

After all of the segments in the image Iₙ are analyzed, compressed and stored, the audio frames are added 48 and stored in conjunction with the segments of the image frame. To complete the series of images in the data stream, the next image Iₙ₊₁ is read into the processor 14. The above described process is repeated until no additional images remain in the data stream for processing. Once no additional images require processing, closing meta-data is written 50 into the data stream. Embodiments of the compression process can be represented by the following summation:

$$C ( {I}_{n} ) {\sum }_{i = 1}^{i = j} {C}_{i} ( {S}_{i} )$$

and the compressed video stream can be represented as follows:

$${\sum }_{n = 1}^{n = g} C ( {I}_{n} ) = {\sum }_{n = {g}_{1}}^{n = g} {[ [ {\sum }_{i = 1}^{i = j} {C}_{i} ( {S}_{i} ) ] ]}_{n}$$

wherein, C₁(x)=compression function; Iₙ=an image; Sᵢ=a segment of an image I; j=total number of segments in image Iₙ; and g=total number of frames/images in the video stream.

The compressed image regions are stored in computer memory until all of the regions have been analyzed and compressed. As discussed above, after the entire image has been compressed, the image data is encoded into a format for playback.

In one preferred embodiment, the encoding is based on a shock wave flash (“SWF”) file-format, however any other file format capable of representing the image data may be used. In preferred embodiments, header information for the SWF file is written into computer storage 16 to mark the beginning of the SWF file. Additional parameters which define the image data may also be written to the SWF file, including, but not limited to, scripting commands, vector or bitmap graphics, or animation data, wherein the commands, vector and bitmap graphic are data structures and commands supported by the SWF file format. Once the header information and any additional user defined data is written to the file header, the encoded video data is written to the file.

Further, user interface controls and interactivity commands are also written to the SWF file. In preferred embodiments, the user interface controls and interactivity commands are tags or bytes written to the SWF file which direct the playback device to perform certain tasks, or act in a particular manner. For example, some commands direct the playback device to respond to a mouse click with a predefined action, such as, launching a web page, or pausing the playback of the video stream.

Prior to writing the compressed data, a delimited tag is written to the file, wherein the delimiter tag is used to instruct the playback device to decompress image or audio data and identifies the beginning of the image or audio data. The delimited tag includes, but is not limited to, information which identifies a particular segment. For instance, in one embodiment, the delimiter tag includes an identifier of the compression technique, identification of the outline of the segment, and boundary points of the segment, wherein the outline information can be a series of straight or curved line segments representing the shape of the encoded region. After the delimited tag is written, the compressed image data of the particular segment is written into the file.

The compressed image data can be any type of data, wherein the compressed image data is defined as the fill of the outline. The compressed pixel data may be defined as a clipped or a tiled bitmap clip, depending on the required fill properties and the size of the outlined region. In one preferred embodiment, the compressed image data is a loss-less pixel data encoded by an LZW compression process. In another embodiment, the data is a lossy pixel data encoded by a discrete cosine transform (“DCT”) based block transform such as joint picture expert group (“JPEG”).

Finally, in some instances, to more effectively store the image data, an affine transform is defined for the outline region with the image fill data, wherein the affine transform defines scaling, rotating and skewing of the data prior to storage of the data. When it is desirable to recreate the data image, the inverse of the affine transform is applied to the outline region and image data fill, so as to scale, skew or rotate the data and to place the filled region on the screen.

As an illustrative example, in one preferred embodiment, a compressed image segment is stored in a lossy format in an SWF file. It is to be understood that some of the following parameters are specific to the SWF format and is not intended to be limiting. The following is a representation of the stored information and comprises memory management, data description and display instructions:

```
tagFreeCharacter tagid 1
tagDefineBitsJPEG2 tagid 1
tagDefineShape tagid 2
    Number of fill styles 1
    Bitmap Fill: 0001
    [20.000 0.000]
    [0.000 20.000] Affine transform instructions
    [0.050 0.250]
    Number of line styles 0
    moveto: (240.05,132.25) -starting point for writing data
    FillStyle1: 1 (1 bit)
    hlineto: (0.05,132.25).
    vlineto: (0.05,0.25).
    hlineto: (240.05,0.25). -region defining data
    vlineto: (240.05,132.25).
    End of shape.
    tagPlaceObject2 flags 22 depth 1 tag 2
    [1.000 0.000]
    [0.000 1.000]
    [0.000 0.000]
    ratio 1
```

The memory management includes a command or instruction that facilitates the maintenance of available memory during playback. In this embodiment, the “tagFreeCharacter” command or instruction ensures that all items in the playback device's memory with a user defined identifier, for example, “1”, are purged and freed from memory. In this manner, the playback device does not exceed its available free memory. If there is no item with the corresponding identifier in memory, this tag is ignored. It is to be understood that this command may be eliminated. However, if the command is eliminated all of image data will be retained in memory and each image segment will be assigned a unique identifier. Thus, the use of memory management, for example, the tagFreeCharacter, ensures that the playback device does not exceed its available RAM during playback as not all of the image segments are retained in memory.

The data description describes the data, including, but not limited to, shape. The first parameter, tagid 1, identifies the image data and the second parameter, tagid 2, defines the shape of the segment. The number of fill styles refers to whether the playback device draws image data or solid colors in a specified region. In some preferred embodiments a plurality of fill styles could be defined, wherein the fill styles would overlap into an adjacent region. The bitmap fill instructs the playback device to paint the image data into the region. The affine transform is represented by a matrix and defines any scaling, rotation or skewing of the image data contained within the region. Finally, the number of line styles represents the border of the data. In some preferred embodiments, no line styles are defined.

To define the data on the display, the display instructions indicate the starting point of the data. The starting point is stored in the parameter ‘moveto’. The parameters hlineto and vlineto define the size of the region with respect to the starting point. Thus, in this instance, the region is a box and commences at the starting point x, y=(240.05, 132.25). The x position is moved from x=240.05 to x=0.05. Once at x=0.05, the vertical position is moved from y=132.25 to y=0.25. Next, the x position is moved from x=0.05 to x=240.05. Finally, once at the position x=240.05 and y=0.25, the y position is moved upwards to y=132.25 to complete the square.

Once the region is defined with respect to the display, a display command is stored that informs the playback device that specific information is defined within the command and instructs the playback device as to how to display the image on the display. The display command is followed by a second affine transform that further scales, rotates and skews the segment in its entirety, if desired.

A second illustrative example, is a compressed image segment stored in a loss-less format

```
in an SWF file:
tagFreeCharacter tagid 1
tagDefineBitsLossless tagid 1
tagDefineShape tagid 2
    Number of fill styles 1
    Bitmap Fill: 0001
    [20.000 0.000]
    [0.000 20.000]
    [0.050 0.250]
    Number of line styles 0
    moveto: (240.05,132.25)
    FillStyle1: 1 (1 bit)
    hlineto: (0.05,132.25).
    vlineto: (0.05,0.25).
    hlineto: (240.05,0.25).
    vlineto: (240.05,132.25).
    End of shape.
tagPlaceObject2 flags 22 depth 1 tag 2
    [1.000 0.000]
    [0.000 1.000]
    [0.000 0.000]
ratio1
```

The parameters defined above are applicable to this example.

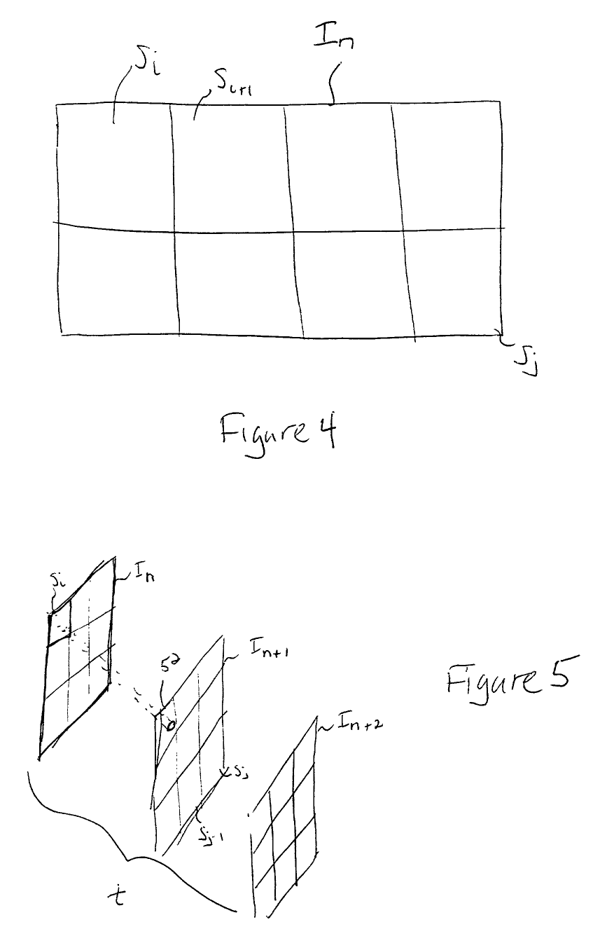

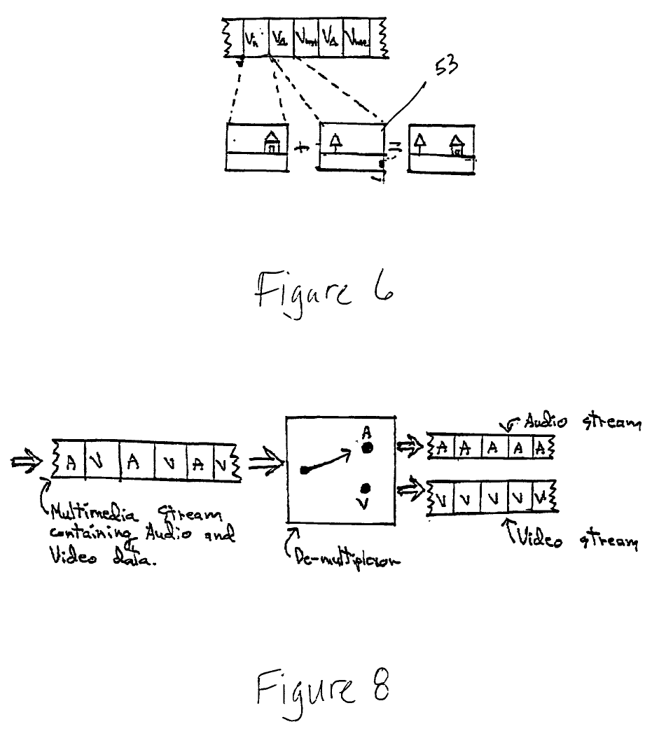

The above description has been directed to the spatial compression for each individual frame in a data stream. However, the temporal compression of the image stream can also be achieved in accordance with the principles described above. With reference to FIG. 5, in preferred embodiments, a first image I₁ resides adjacent a second image I₂. In accordance with the process described above, the first image I₁ has been defined via a plurality of segments S₁, . . . Sⱼ. A comparison is made of a first segment Sᵢ and a first corresponding portion 52 in the second image I₂. Only the differences between the first segment Sᵢ and the first corresponding portion 56 are recorded. In this manner, fewer packets of information are required to be stored, thereby reducing the storage requirements. With reference to FIG. 6, the resulting video stream contains delta frames 53, wherein the delta frame 53 contains the differences that exist between two adjacent frames. During the display of the video stream, the first full frame can be displayed and subsequent delta frames are overlayed onto the full frame such that a sequence of frames is displayed without the requirement that each entire frame be compressed and stored.

Comparisons are made between each segment of the first image Iₙ and the corresponding portions 56 of the second image Iₙ₌₁. Once the comparisons are completed, a comparison commences between the second image Iₙ₊₁ and the third image I₊₂, wherein a comparison is made between the third image and the identical regions of the first and second image as stored, and the third image and the data portions of the second image that differed from the first image. Only the nonidentical portions of third image and the second image are recorded. This comparison continues for a predefined set of images, wherein the predefined number of images corresponds to a predefined time period t. It is to be understood that the above described process can be performed on “n” number of images, wherein “n” is user defined.

In some preferred embodiments, temporal compression occurs simultaneously with the spatial compression. The order of operations is dependent on the specific compression techniques used. In some compression techniques, temporal compression and spatial compression applied simultaneously will yield higher compression ratios or better perceptive quality at the same data size than temporal compression and spatial compression applied discretely.

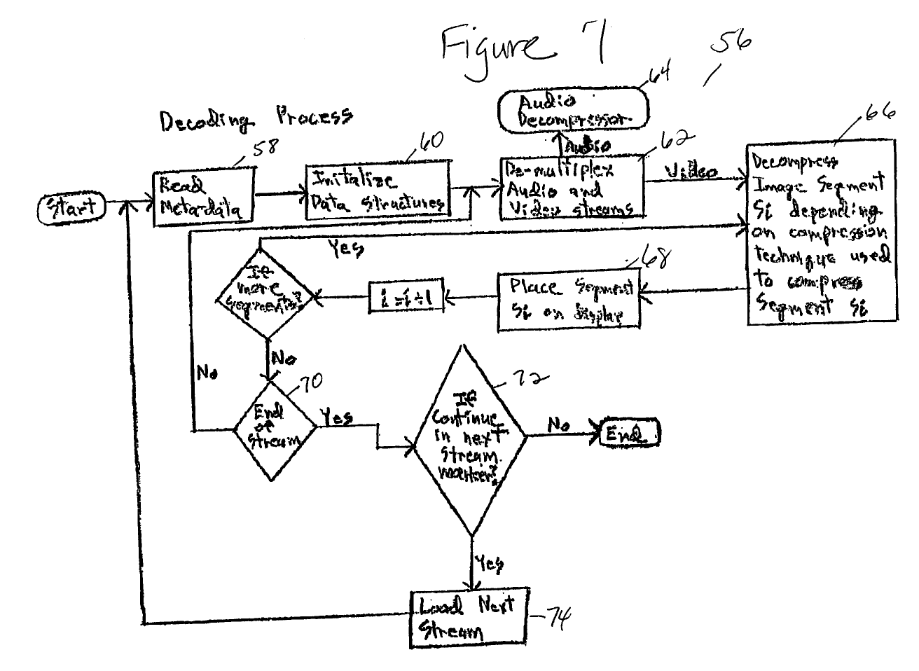

Once the data has been compressed, the data is stored in a data storage device 16 for future use. When a user desires to view the compressed data, the user engages the decompression process 56. With reference to FIG. 7, embodiments of the decoding, or decompression process commence the decoding process 56 by reading the meta-data 58 contained within the header file of the compressed image. The meta-data instructs the computer as to file structure, contents and other user defined data.

Once the meta-data is read, the appropriate data structures contained within the computer memory are initialized 60, that is, the data structures required for the stored data are created in memory. After the data structures have been initialized, the audio and video streams are de-multiplexed 62 such that the audio stream is separated from the video stream (See FIG. 8) and stored in the data structures. Upon separation the audio stream is decompressed 64 in accordance with the compression technique used to compressed the audio stream.

With respect to the image data, the image data is decompressed per segment Si, wherein the decompression of each segment Si depends upon the compression technique utilized to compress the segment Sᵢ 66. As each segment Sᵢ is decompressed, the segment is displayed on the display device 68. The process then proceeds to the next segment Sᵢ₊₁, decompresses the next segment and displays the next segment Sᵢ₊₁. This process continues until there are no further segments. Once all of the segments of a first image in the data stream is decompressed, the process proceeds to the next image in the data stream 70. The above process is then repeated until each image in the data stream is decompressed. Upon completion of the first data stream, the process determines whether a subsequent data stream is stored 72. If a second data stream is stored, the next stream is loaded 74 and the meta-data for the second data stream is read. The above described decoding process continues for each data stream. Once all of the data streams have been processed, the decoding process is completed. In the preferred embodiments of the decoding process, the uncompressed video stream can be represented by the following summation:

$$U = {\sum }_{n = 1}^{∞} {\sum }_{i = 1}^{∞} {F}_{n}^{- 1} [ {H}_{n}^{- 1} ( {S}_{i} ) ]$$

wherein H⁻¹ (x) is the inverse compression function.

Although the above describes basic embodiments of the invention, it is not intended to limit the invention. Indeed, variations on the manner in which data is compressed and stored is envisioned. For instance, in one preferred embodiment, information is shared between discrete image segments. In this manner, storage requirements are reduced and in some instances, a greater efficiency of computer resources can be achieved. For example, lossy compressed image segments having an SWF file format may share JPEG encoding tables, wherein in one embodiment, the encoding tables define header information common to the JPEG image. In this instance, the SWF file format includes a “tagJPEGTables” instruction and data which represents the JPEG encoding tables. All image segments are then defined by “tagDefineJPEG” instructions and data. As all the image segments are defined by one set of instructions and data, a reduction of the number of bits required in the final output stream can be achieved. In addition to the sharing of encoding tables, the image segments may also be encoded with an alpha channel or transparency information, which instructs the playback device to ‘blend’ the pixels already on the display with the data defined in the image, thereby increasing compression yields in the spatial and temporal dimensions. In still further embodiments, a set of equivalent instructions having greater or fewer attributes and capabilities may be substituted for the instructions listed in the described embodiments with similar visual results, thereby further reducing storage requirements.

In addition to variations regarding the manner of compression and storage of data, the type of data representation can be varied. In the above described embodiments, the image data is represented as a pixel, or point, data. In other preferred embodiments, each image segment, or complete image frame, is represented as a series of line segments, wherein the input image stream is analyzed and transformed into the series of line segments, wherein the line segments can be non-overlapping or overlapping. Depending upon the nature of the image segment represented by the lines, the line segments may be a series of continuous line segments or polylines. The lines may be of varying length and width, or thickness, and may be of a single color or a gradient of colors. In addition, lines may also delimit areas of color or gradient color, thereby saving bits in the output stream. A combination of lines delimiting filled areas and lines of varying thickness and color may be employed to yield the greatest compression ratios.

In another preferred embodiment, vector quantization is used to represent the image data.

In a vector quantization representation, an image frame is divided into segments and the segments are stored in an addressable image dictionary. The image dictionary is used to create a collage of image segments that are placed onto the display to recreate the input image. When the image is initially analyzed and broken into segments, each segment is compared to entries in the dictionary to determine whether any dictionary entry is similar to the segment currently being analyzed, wherein the ‘similarity’ of the entries can be measured by computing the root-mean-square (“RMS”) error between the pixel values of the original segment and the pixel values of the corresponding dictionary entry. It is to be understood that any relevant type of measurement of error can be used, including, but not limited to, other statistical based error calculations. The image segments for a given image must be representative of the entire image, however, there are no restrictions to the size or shape of each image segment. Thus, image segments can be divided in accordance with the contents of the image data. If a dictionary entry is adequately similar to the segment in question, a pointer to the dictionary is stored in the compressed output, wherein the adequacy is defined as less than a predefined RMS error. If a sufficiently similar dictionary entry is not found, the image segment under analysis is entered into the dictionary and a pointer to the new entry is placed into the output stream. Finally, the complete dictionary is appended to the output stream. In another embodiment, the data for each dictionary entry is inserted into the output stream before the entry's first use. This allows for smoother transmission of data since only information that is currently needed is read into the playback device's memory. Further, if the compressor determines that an image segment can be reproduced by transforming an already existing dictionary entry by an affine transformation or a color transformation, the compressor stores instructions describing the transformation in the output stream.

In preferred embodiments, a single dictionary can be used for successive images or frames in a video stream. In this manner, successive frames can reference an entry in the dictionary if a segment match occurs such that a single dictionary might be applicable to an entire data stream. In some preferred embodiments, a counter reflecting the number of times a dictionary entry has been referenced is maintained, thereby allowing the encoding apparatus to adaptively control the size and entries of the dictionary as needed. More specifically, dictionary entries with a high count may be stored at a greater quality than entries with a lower count, thereby improving the perceived quality of the entire stream without decreasing compression. In contrast, dictionary entries with a low count can be removed from the dictionary after they have been displayed. Further, instructions can be placed in the output stream by the encoder to reflect changes in the dictionary as they occur, thereby keeping the dictionary synchronized during the encoding and decoding process.

The above-described embodiments of the present invention are not intended to limit the manner in which segments of a data frame in a data stream are compressed and decompressed. Indeed, as better techniques for compression and decompression become available, embodiments of the present invention are configured to readily incorporate new techniques and apply these techniques to the portions of segments of image frames without affecting the essence of the embodiments of the invention. Indeed, the disclosure is intended to include other preferred embodiments encompassing other compression and decompression techniques. Further, the manner in which the spatial and temporal compression is performed for a data stream is not intended to be limited by the above described embodiments. For instance, in other preferred embodiments, the temporal compression can be performed contemporaneously with the spatial compression. As such, the foregoing is intended to cover all modifications and alternative constructions falling within the spirit and scope of the invention.

What is claimed is:

1. A compression process for compressing an image and storing the compressed image on a storage medium of a computer system, wherein a plurality of compression techniques are utilized to compress the image, comprising:
segmenting the image into a plurality of n segments;
analyzing a first segment of the plurality of segments to determine a first optimal compression for the first segment;
applying the first compression technique to the first segment;
storing the compressed first segment in the storage medium;
analyzing a subsequent segment in the plurality of segments to determine a second optimal compression for the subsequent segment;
applying the second compression technique to the subsequent segment;
storing the compressed subsequent segment in the storage medium; and
repeating the steps of analyzing, applying and storing for each segment in the plurality of segments, wherein the nth segment is compressed by an nth compression technique.

2. A compression process as claimed in claim 1, wherein the first compression technique and the second compression technique are different.

3. A compression process as claimed in claim 1, wherein at least two different compression techniques are applied to the plurality of segments.

4. A compression process as claimed in claim 1, wherein storing the compressed segment comprises writing a data file comprising data description members and display instruction members.

5. A compression process as claimed in claim 4, wherein storing the compressed segment comprises writing a data file further comprising memory management.

6. A compression process as claimed in claim 4, wherein storing the compressed segment comprises writing a data file selected from the group consisting of memory management, data description members and display instruction members.

7. A compression process for compressing an image stream having a plurality of images and storing the compressed images on a storage medium of a computer system, wherein a plurality of compression techniques are utilized to compress each image, comprising:
segmenting a first image into a plurality of n segments;
analyzing a first segment of the plurality of segments to determine a first optimal compression for the first segment;
applying the first compression technique to the first segment;
storing the compressed first segment in the storage medium;
analyzing a subsequent segment in the plurality of segments to determine a second optimal compression for the subsequent segment;
applying the compression technique to the subsequent segment;
storing the compressed subsequent segment in the storage medium;
repeating the steps of analyzing, applying and storing for each segment in the plurality of segments;
segmenting each subsequent image into a plurality of segments; and
repeating the steps of analyzing, applying and storing for each segment in each subsequent image.

8. A compression process as claimed in claim 1, wherein the first compression technique and the second compression technique are different.

9. A compression process as claimed in claim 1, wherein at least two different compression techniques are applied to the plurality of segments.

10. A compression process as claimed in claim 1, wherein storing the compressed segment comprises writing a data file comprising a memory manager, data description members and display instruction members.

11. A file structure for storing compressed data in a data file, wherein the data file can be displayed on a playback device having a predefined amount of memory, comprising:
a memory management command in a first position in the data file, wherein the memory management command instructs the playback device to perform a predefined operation;
a set of data description members; and
a set of display instructions, wherein the display instructions include a starting data point, and size parameters of the data.

12. A file structure as claimed in claim 11, wherein the data description members, comprise:
an image identifier;
an image shape identifier; and
identifier of the number of fill styles, wherein the fill styles define the type of data in the segment;
a data draw command, wherein the data draw command instructs the playback device to display the data; and
a first affine transform, wherein the transform defines scaling, rotating or skewing of the data contained within the segment.

13. A file structure as claimed in claim 12, wherein the fill styles are selected from a group consisting of solid color data, gradient data, bitmap data, or pixel data.

14. A file structure as claimed in claim 13, further comprising a second affine transform, wherein the transform defines scaling, rotating or skewing of the segment.
